(19) United States
(12) Patent Application Publication
(10) Pub. No.: US 2012/0204967 A1
(43) Pub. Date: Aug. 16, 2012

(54) Device For Ventilating A Compartment

(75) Inventor: Yannick Sommerer, Cornebarrieu (FR)

(73) Assignee: AIRBUS OPERATIONS (S.A.S.), Toulouse Cedex (FR)

(21) Appl. No.: 13/366,781

(22) Filed: Feb. 6, 2012

(30) Foreign Application Priority Data
Feb. 14, 2011 (FR) 11 51187

(51) Int. Cl. F02C 7/04

(52) U.S. Cl. 137/15.1

(57) ABSTRACT

A ventilation device for a compartment, preferably a compartment of an aircraft engine, the device including an air intake adapted to capture a flow of air outside the compartment, an air diffuser adapted to guide the air flow into the compartment, and an air distributor adapted to distribute the air flow within the compartment, the air distributor in this device being separated from the air diffuser, and being placed inside the compartment at a distance from the air diffuser

### TECHNICAL FIELD

The invention relates to the field of ventilating a compartment, that is to say a volume delimited by a plurality of partitions, by circulating a flow of air in the compartment. More specifically, the aim of the invention is to provide ventilation of at least one aircraft engine compartment by circulating a flow of air drawn from outside the engine.

An aircraft engine conventionally includes a plurality of compartments which have to be ventilated in order to cool the components located in each compartment, for example, or in order to renew the air so as to remove any fuel vapour from the compartment.

In order to renew the air in an engine compartment, a flow of air must be taken from outside the compartment, guided into the compartment, and finally directed within the compartment to achieve the desired result (cooling, removal of fuel vapours, etc.). For this purpose, a conventional ventilation device is made, in a known way, in the form of a one-piece unit, including an air intake for collecting a flow of air outside the compartment, an air diffuser for guiding the flow of collected air into the compartment, and an air distributor for directing the air flow within the compartment. The distributor of a ventilation device can be made in various forms for the purpose of directing the air flow in a precise way within the compartment.

Conventionally, the air flow is captured by the air intake as a result of the pressure difference between the air pressure outside the compartment and the air pressure inside it. In order to provide optimal ventilation of the compartment, the ventilation device must collect a large air flow while limiting the pressure drops in the various parts of the device, namely the air intake, diffuser and distributor.

### PRIOR ART

One of the principal drawbacks of a prior art ventilation device is that the air distributor creates large pressure drops, which adversely affect the performance of the ventilation device, and, more generally, that of the aircraft.

In order to overcome this drawback and maintain a large air flow while allowing for the pressure drops created by the distributor, a solution has been proposed according to which the dimensions of the air scoop of the air intake are increased. However, this solution has the drawback of increasing the parasitic drag of the intake, which reduces the performance of the aircraft.

In practice, the air distributor is configured so as to direct the air flow within the compartment while limiting the pressure drops. In other words, the configuration of the air distributor is the result of a compromise between the deflection angle of the air flow which provides the distribution of air in the compartment and the pressure drops caused by this deflection. In order to compensate for this insufficient ventilation, a surplus amount of extinguishing agent is conventionally injected into the engine compartment to provide optimal protection against fire. However, this requires an increase in the dimensions and weight of the fire extinguishing system, and consequently of the aircraft itself, which is disadvantageous.

### SUMMARY OF THE INVENTION

The invention was originally devised for the purpose of ventilating an aircraft engine compartment, but it is more generally applicable to the ventilation of any compartment in which a flow of air has to be directed in an optimal manner.

In order to eliminate at least some of the drawbacks mentioned, the invention proposes a ventilation device for a compartment, preferably an aircraft engine compartment, the device including an air intake adapted to capture a flow of air outside the compartment, an air diffuser adapted to guide the air flow into the compartment, and an air distributor adapted to distribute the air flow within the compartment, the air distributor in this device being separated from the air diffuser, and being placed inside the compartment at a distance from the air diffuser.

Since the air distributor is separated from the air diffuser, the air flow is distributed in the compartment by the distributor at the air pressure of the compartment, and not at the air pressure of the diffuser, thus decreasing the pressure drops in the ventilation device.

Additionally, since the distributor is independent of the diffuser, the size and configuration of the air distributor can advantageously be determined as required in order to guide and distribute the air flow in the desired areas of the compartment.

Preferably, the air distributor is positioned facing the air diffuser in the compartment, enabling the intake air flow to be distributed in an optimal manner. The air flow leaving the diffuser is thus directly guided towards the distributor so that it can be directed within the compartment.

Preferably, since the air diffuser is configured to guide the air flow in a rectilinear direction of diffusion, the air distributor is positioned in the linear direction of diffusion. The air flow is distributed by the ventilation device according to the invention in substantially the same way as in a prior art device, which is highly advantageous, only the pressure drops being reduced.

Preferably, the walls of the air distributor are placed at a distance of at least 1 cm from the walls of the air diffuser, to permit an air flow distribution which limits the pressure drops caused by the distributor. Preferably, also, the walls of the air distributor are at a distance of between 3 and 6 cm from the walls of the air diffuser, to achieve a compromise between the limitation of the pressure drops of the distributor and an optimal direction of the air flow.

According to one aspect of the invention, the air distributor includes vanes arranged to distribute the air flow vertically and horizontally. Thus the air flow is distributed within the compartment according to the desired result. Since the distributor is independent of the diffuser, the configuration of the distributor vanes can be freely determined, thus improving the quality of the guiding of the air flow by the distributor.

Preferably, the air distributor is fixed to a wall of the compartment. Thus, by contrast with the prior art, in which the diffuser and the distributor form a single element, the distributor is separated from the diffuser and is fixed to a wall of the compartment. By positioning the distributor in a precise way with respect to the compartment, the air flow can be guided in a precise way within the compartment.

The invention also relates to an assembly composed of an aircraft nacelle and an aircraft engine mounted in the nacelle so as to create at least one compartment between the engine and the nacelle, the assembly including a ventilation device as described above.

The distributor of the ventilation device is thus advantageously positioned in the compartment formed between the nacelle and the engine, enabling the fuel vapour to be ventilated efficiently when the aircraft is flying.

According to a first aspect, the distributor of the ventilation device is fixed firmly to the nacelle, preferably to the cowling of the nacelle. The distributor can thus resist vibrations during the flight of the aircraft. According to a second aspect, the distributor of the ventilation device is fixed firmly to the engine, preferably to the engine casing.

### BRIEF DESCRIPTION OF THE DRAWINGS

The invention will be more clearly understood with the aid of the following description, provided solely by way of example, with reference to the attached drawings, of which:

FIG. 1 is a schematic cross section through an aircraft engine with a ventilation device according to the invention; and

FIG. 2 is a schematic perspective view of a ventilation device according to a preferred embodiment of the invention.

### DETAILED DESCRIPTION

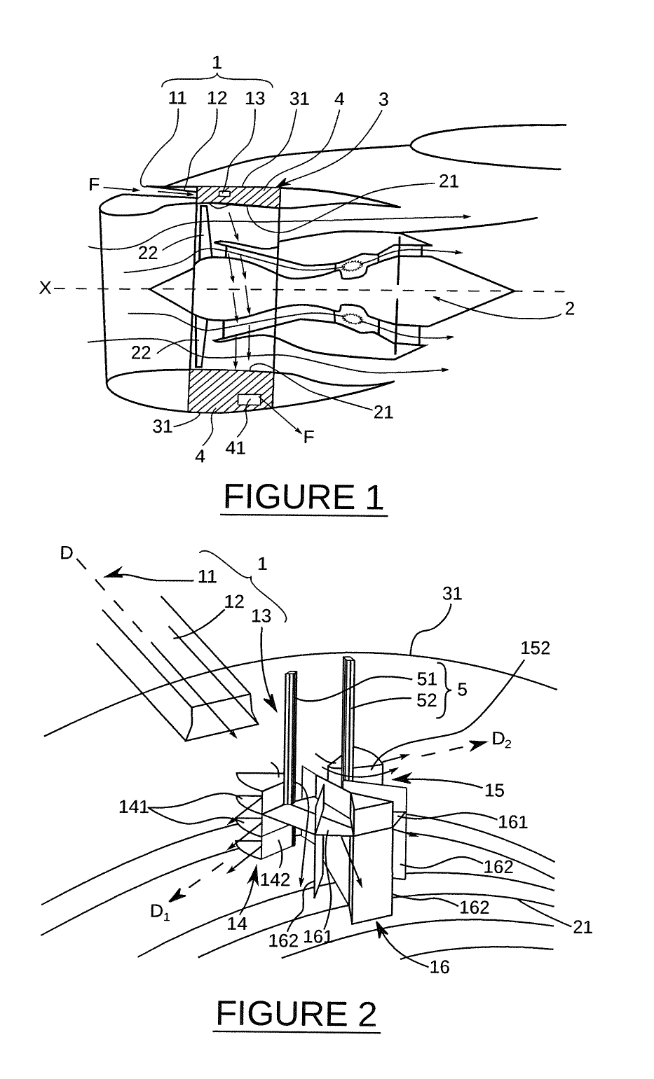

A description is given below of a ventilation device 1 according to the invention for ventilating a compartment 4 of an aircraft engine 2, the engine 2 extending in an axial direction X shown in FIG. 1. In this example, since the engine 2 is mounted in a nacelle 3, the ventilation device 1 according to the invention is arranged to ventilate a compartment 4 delimited by the casing 21 of the engine 2 and by the cowling 31 of the nacelle 3. The compartment 4, shown by hatching in FIG. 1, forms an annular volume located between the casing 21 of the engine 2 and the nacelle 3. In this example, the compartment 4 is delimited internally by the fan casing of the engine 2 in which fan blades 22 are driven.

As shown schematically in FIG. 1, the ventilation device 1, located in an upper part of the compartment 4, includes an air intake 11 adapted to capture an air flow F outside the engine 2, an air diffuser 12 adapted to guide the air flow F into the compartment 4, and an air distributor 13 adapted to distribute the air flow F within the compartment 4. For the sake of clarity, the ventilation of the compartment by the circulation of the air flow F is indicated by arrows drawn in solid lines in FIGS. 1 and 2. After circulating in the compartment 4, the air flow F is expelled from the compartment 4 through an air outlet 41 located in a lower part of the compartment 4, as shown in FIG. 1.

In this example, the air intake 11 enables an air flow F to be captured by the air pressure difference between the outside and the inside of the compartment 4, and the captured air flow F is then directed by the diffuser 12 into the compartment 4. For this purpose, as shown in FIGS. 1 and 2, the diffuser 12 is tubular in shape and is fixed to the intake 11. Preferably, the intake 11 and the diffuser 12 are made in one piece.

The distributor 13 of the ventilation device 1 is separated from the diffuser 12, as shown in FIGS. 1 and 2, in such a way that the pressure drops in the course of ventilation are decreased. With reference to FIG. 1, the distributor 13 is positioned in the compartment 4 at a distance from the diffuser 12. Preferably, the walls of the diffuser 12 are separated from the walls of the distributor 13 by a distance of at least 1 cm, and preferably a distance of between 3 cm and 6 cm.

Thus the air flow F is distributed within the compartment 4 at the air pressure of the compartment 4, and not at the pressure of the diffuser 12, enabling the pressure drop associated with the air distribution to be limited. Additionally, the distributor 13 is independent of the diffuser 12, allowing greater freedom in the positioning and size of the distributor 13 by comparison with a prior art ventilation device.

In this example, the distributor 13 is connected by fastening means 5 to the cowling 31 of the nacelle 3, the cowling 31 thus having a considerable vibration resistance which is advantageous. Clearly, the distributor 13 could also be mounted on the casing 21 of the engine 2 so as to limit the length of the fastening means 5 of the distributor 13.

With reference to FIG. 2, the distributor 13 is mounted facing the diffuser 12, so that the air flow F leaving the diffuser 12 is guided directly towards the distributor 13 in the compartment 4. In this example, the diffuser 12 takes the form of a tubular duct extending along a diffusion axis D, the distributor 13 being positioned in the diffusion axis D as shown in FIG. 2.

The distributor 13 of the ventilation device 1 can be made in various shapes in order to distribute the air flow F within the compartment 4 according to the desired result. With reference to FIG. 2, the distributor 13 includes a plurality of distribution modules 14, 15, 16, connected to the cowling 31 of the nacelle 3 by fastening means 5 which, in this example, are made in the form of vertical rods 51, 52, in order to position the distributor 13 in the diffusion axis D. The invention is illustrated, by way of example, with a distributor 13 fastened to the cowling 31 of the nacelle 3, but the distributor 13 could be connected to any wall of the compartment 4, such as the casing 21 of the engine 2, or to a component of the engine 2 located in the compartment 4, in order to limit the length of the fastening means 5.

As shown in FIG. 2, the first distribution module 14, connected to the first vertical rod 51, has a plurality of horizontal vanes 141 for the purpose of dividing the air flow F in the vertical direction. The horizontal vanes 141 of the first distribution module 14 are fixed to a vertical vane 142, which is fixed to the first vertical rod 51 and has the function of modifying the incident direction of the air flow F. With reference to FIG. 2, the first distribution module 14 changes the incident direction of the air flow F to a first distribution direction D1 while dividing the air flow F in the vertical direction.

Similarly, the second distribution module 15, connected to the second vertical rod 52, has a plurality of horizontal vanes (not visible in FIG. 2) for the purpose of dividing the air flow F in the vertical direction. The horizontal vanes of the second distribution module 15 are fixed to a vertical vane 152, fixed to the second vertical rod 52, and having the function of modifying the incident direction of the air flow F. With reference to FIG. 2, the second distribution module 15 changes the incident direction of the air flow F to a second distribution direction D2 while dividing the air flow F in the vertical direction.

The third distribution module 16 is positioned, in this case, between the first and second distribution modules 14, 15, and is connected to the two vertical rods 51, 52. The third distribution module 16 includes a plurality of horizontal vanes 161 and vertical vanes 162 such that the incident air flow F is distributed in a plurality of distribution directions.

In this example, the vanes of the distribution modules 14, 15, 16 are flat, but clearly they could have different curvatures in order to guide the air flow F to the desired regions of the compartment 4. Additionally, the orientation of the vanes is determined as a function of the relative position of the diffuser 12 with respect to the distributor 13, in order to provide optimal guidance of the air flow F within the compartment 4.

In this example, the vertical vanes 162 of the third distribution module 16 are positioned in such a way that the air flow F is divided equally between the first and second distribution modules 14, 15. Clearly, the vertical and horizontal vanes of the ventilation device 1 can be positioned so as to provide more ventilation in one part of the compartment 4, or to create, for example, an asymmetric or rotating flow or a flow directed along one side of the compartment only. The size of the vanes and the positioning of the vanes with respect to each other will enable some or all of the air flow F to be distributed into the chosen parts of the compartment 4.

The ventilation device 1 according to the invention reduces the pressure drops associated with the distributor 13, thus increasing the ventilation efficiency. Advantageously, the dimensions of the intake 11 can be reduced, thus limiting the parasitic drag of the aircraft.

1-9. (canceled)

10. Assembly composed of an aircraft nacelle and an aircraft engine mounted in the nacelle so as to create at least one compartment between the engine and the nacelle, the assembly including a ventilation device for the compartment, the device including:
an air intake adapted to capture an air flow outside the compartment,
an air diffuser adapted to guide the air flow into the compartment, and
an air distributor adapted to distribute the air flow within the compartment,
the device being characterized in that the air distributor is separated from the air diffuser, the air distributor being positioned within the compartment at a distance from the air diffuser.

11. Assembly according to claim 10, in which the air distributor is positioned facing the air diffuser in the compartment.

12. Assembly according to claim 10 in which, since the air diffuser is configured to guide the air flow in a rectilinear direction of diffusion D, the air distributor is positioned in the rectilinear direction of diffusion D.

13. Assembly according to claim 10, in which the walls of the air distributor are at a distance of at least 1 cm from the walls of the air diffuser.

14. Assembly according to claim 13, in which the walls of the air distributor are at a distance of between 3 and 6 cm from the walls of the air diffuser.

15. Assembly according to claim 10, in which the air distributor includes vanes arranged to distribute the air flow vertically and horizontally.

16. Assembly according to claim 10, in which the air distributor is fixed to a wall of the compartment.

17. Assembly according to claim 10, in which the distributor of the ventilation device is fixed to the nacelle, preferably to the cowling of the nacelle.

18. Assembly according to claim 10, in which the distributor of the ventilation device is fixed to the engine, preferably to the casing of the engine.
